(19) United States
(12) Patent Application Publication
(10) Pub. No.: US 2024/0022948 A1
(43) Pub. Date: Jan. 18, 2024

(54) ON DEMAND CELL-SITE INFORMATION COLLECTION IN A CLOUD 5G ENVIRONMENT

(71) Applicant: DISH Wireless L.L.C., Littleton, CO (US)

(72) Inventors: William Charles Beckwith, Washington, DC (US); Mehdi Alasti, Arlington, VA (US)

(21) Appl. No.: 18/220,967

(22) Filed: Jul. 12, 2023

Related U.S. Application Data
(60) Provisional application No. 63/388,521, filed on Jul. 12, 2022.

(51) Int. Cl. H04W 28/02; H04L 5/00; H04W 8/18

(52) U.S. Cl. CPC H04W 28/0226; H04L 5/0048; H04W 8/18

(57) ABSTRACT

A method may include receiving, by a radio unit (RU), a mobile communication from a user device, the RU associated with a cell identifier (CID). The method may include determining, by an access and mobility function (AMF), an attribute associated with the user device and the mobile communication. The method may include generating, by a core network function, a communication record of the mobile communication including the CID and the attribute. The method may include storing, by a computing device, the communication record in a database. The method may include receiving, by the computing device, a request for communication records including a requested attribute type. The method may then include determining, by the computing device, that the attribute of the communication record is of the requested attribute type. The method may include transmitting, by the computing device of the cellular network, the communication record based on the request.

### CROSS REFERENCE TO RELATED APPLICATION

This application claims priority to U.S. Provisional Patent Application No. 63/388,521, filed on Jul. 12, 2022, the disclosure of which is incorporated by reference in its entirety for all purposes.

### BACKGROUND

This disclosure relates generally to the field of wireless cellular communication. Specifically, this description relates to the gathering and filtering of cellular data, such as in response to a lawful request.

### BRIEF SUMMARY

In an embodiment, a method may include receiving, by a radio unit (RU) of a cellular network, a mobile communication from a user device, the RU associated with a cell identifier (CID). The method may also include determining, by an access and mobility function (AMF) of the cellular network, an attribute associated with the user device and the mobile communication. The method may include generating, by a core network function of the cellular network, a communication record of the mobile communication, the communication record may include the CID and an indication of the attribute. The method may include storing, by a computing device of the cellular network, the communication record in a database. The method may also include receiving, by the computing device of the cellular network, a request for communication records, the request may include a requested attribute type. The method may then include determining, by the computing device of the cellular network, that the attribute of the communication record is of the requested attribute type. In response to determining that the attribute of the communication record is of the requested attribute type, the method may include transmitting, by the computing device of the cellular network, the communication record based on the request.

In some embodiments, the communication record may be a call data record and may include information associated with the mobile communication and the CID. The attribute may include at least one of a time window, an international mobile equipment identity of the user device, an international mobile subscriber identity (CID), a communication length, a session identifier, and a location associated with RU.

In some embodiments, the mobile communication may include a short message service (SMS) communication. The method may then include accessing, by the core network function of the cellular network, an interface for extracting data associated with the SMS communication from at least one of an internet protocol multimedia subsystem (IMS) and a non-access stratum (NAS). The method may also include extracting, by the core network function of the cellular network, the data associated with the SMS communication from the IS and/or the NAS. The method may also include generating, by the core network function of the cellular network, the communications record based at least in part on the data associated with the SMS communication.

In some embodiments, the mobile communication may include a multimedia messaging service (MMS) communication. The method may then include accessing, by the core network function of the cellular network, an interface for extracting data associated with the MMS communication from an internet protocol multimedia subsystem (IMS). The method may include extracting, by the core network function of the cellular network, the data associated with the MMS communication from the IMS. The method may then include generating, by the core network function of the cellular network, the communications record based at least in part on the data associated with the MMS communication.

In some embodiments, the cellular network may include a standalone 5g network. The standalone 5g network may include an open radio access network. The standalone 5g network may include one or more of the AMF, a session management function (SMF), a short message service center (SMSC), a call session control function (CSCF), a multimedia message service center (MMSC), the computing device, and the database in a distributed cloud architecture. The communications record may be modified to replace a gNodeB identifier with the CID.

In an embodiment, a system may include one or more processors. The system may include a non-transitory computer-readable medium containing instructions. When executed by the one or more processors, the instructions may cause the system to perform operations. According to the instructions, the system may receive, by a radio unit (RU) of a cellular network, a mobile communication from a user device, the RU associated with a cell identifier (CID). The system may then determine, by an access and mobility function (AMF) of the cellular network, an attribute associated with the user device and the mobile communication. The system may generate, by a core network function of the cellular network, a communication record, the communication record may include the CID and an indication of the attribute. The system may store, by a computing device of the cellular network, the communication record in a cloud-based database. The system may receive, by the computing device of the cellular network, a request for communication records, the request including a requested attribute type. The system may determine, by the computing device of the cellular network, that the attribute of the communication record is of the requested attribute type. In response to determining that the attribute of the communication record is of the requested attribute type, the system may transmit, by the computing device of the cellular network, the communication record based on the request.

In some embodiments, a distributed unit (DU) may be associated with the RU and at least one other RU. A centralized unit (CU) may be associated with the DU and at least one other DU, the CU characterized by a gNodeB identifier. The communications record may be modified to replace the gNodeB identifier with the CID. The cellular network may include a standalone 5g network. The standalone 5g network may include one or more components distributed in a cloud architecture. The core network function may include at least one of, a session management function (SMF), a short message service center (SMSC), a call session control function (CSCF), and a multimedia message service center (MMSC). The attribute may include at least one of a time window, an international mobile equipment identity of the user device, international mobile subscriber identity (CID), a communication length, a session identifier, and a location associated with RU. The communications record may be generated by the core network function in conjunction with another network function of the cellular network. The cloud-based database and one or more network functions of the cellular network may be hosted in a public cloud service. The mobile communication may be a voice over new radio (VONR) communication.

In an embodiment, a computer-readable, non-transitory computer memory may include instructions. When executed by one or more processors, the instructions may cause the one or more processors to perform operations. The operations may include determining, by an access and mobility function (AMF) of a cellular network, an attribute associated with a user device and a mobile communication. The operations may include generating, by a core network function of the cellular network, a communication record of the mobile communication including a cell identifier (CID) and an indication of the attribute. The operations may also include storing, by a computing device of the cellular network, the communication record in a database. The operations may then include receiving, by the computing device of the cellular network, a request for communication records with a requested attribute type. The operations may then include determining, by the computing device of the cellular network, that the attribute of the communication record is of the requested attribute type. In response to determining that the attribute of the communication record is of the requested attribute type, the operations may include transmitting, by the computing device of the cellular network, the communication record based on the request.

### BRIEF DESCRIPTION OF THE DRAWINGS

FIG. 1A illustrates an embodiment of a cellular network system, according to certain embodiments.

FIG. 1B illustrates an embodiment of a core of a cellular network system, according to certain embodiments.

FIG. 2 illustrates an embodiment of a cellular network core network topology as implemented on a public cloud-computing platform.

FIG. 3 illustrates a system and a process for collecting and providing cell-site information, according to certain embodiments.

FIG. 4 illustrates a simplified diagram of a system for collecting cell-site information, according to certain embodiments.

FIG. 5 illustrates a flow chart of a method for collecting and providing cell-site information, according to certain embodiments.

### DETAILED DESCRIPTION

During the course of an emergency and/or an investigation, a law enforcement agency (LEA) may request communications data in a given region pursuant to a warrant. For example, an LEA may request data associated with all mobile communications made within five blocks of an address in a time window surrounding an event (e.g., a four-hour time window surrounding a bank robbery). The requested data may include various information about the equipment used to make the mobile communication, sender/recipient information, and other such information. To fulfil the request, a cellular network provider may first generate records of all mobile communications made via their cellular network and infrastructure as the mobile communications are made. When the request comes in, the cellular network provider must determine which cell-site(s) (e.g., a base station) correspond to the location, and then filter the records such that only those the records associated with the base stations corresponding to the location are provided.

Legacy cellular networks, and those using legacy backends, may be able to generate logs of mobile communications using exact cell identifiers (CIDs) or a proxy therefor. For example, a 4G network may include an eNodeB identifier associated with a base station of the 4G network. A mobility management entity (MME) of the 4G network may generate a log including an eNodeB identifier. Similarly, a non-standalone 5G network may also include the node ID in a log, as the non-standalone 5G network may utilize a 4G core (and thus include an MME). An architecture of these cellular networks may have one node (e.g., an eNodeB) per base station and/or location, each base station having a CID. In other words, these legacy cellular networks may include a one-to-one correspondence between the node ID and a CID. Including the node ID (either eNodeB or gNodeB) in a log may thus identify the CID appropriately.

A standalone 5G cellular network, by contrast, may include several radio units (RUs) with respective CIDs. However, in a standalone 5G cellular network, each node may not be tied to a single RU. The node in the standalone 5G cellular network (sometimes, “gNodeB”) may perform various functions in conjunction with the several RUs. Thus, identifying the gNodeB in a record may return a large number of CIDs, without the specificity needed to comply with the request without releasing too much irrelevant information. Furthermore, off-the-shelf network functions used in the standalone 5G cellular network may not be capable of generating logs. Therefore, systems and techniques to generate communications records may be needed to respond appropriately to requests from LEAs, while not releasing more information than necessary.

One solution may be to modify a call data record (CDR) to include the appropriate information. A CDR may be generated by the cellular network provider in order to perform various services both internally and for a user of the cellular network (e.g., billing services). The CDR may include some information about a mobile communication, such as one or more attributes may include a service type, a session ID, a start and end time of the mobile communication, an international mobile equipment identity (IMEI) associated with a user device, and other such information. The CDR may also include the gNodeB ID. Computing devices and/or network functions of the cellular network provider may be modified to generate a CDR that includes a CID. The CDR may then be stored for later access in response to a request from an LEA. A network function of the cellular network may also be modified to generate a log including the CID as a mobile communication is made. The log may be generated in addition to or instead of the CDR. Thus, records corresponding to specific cell-sites may be collected and later provided to an LEA in response to a lawful request.

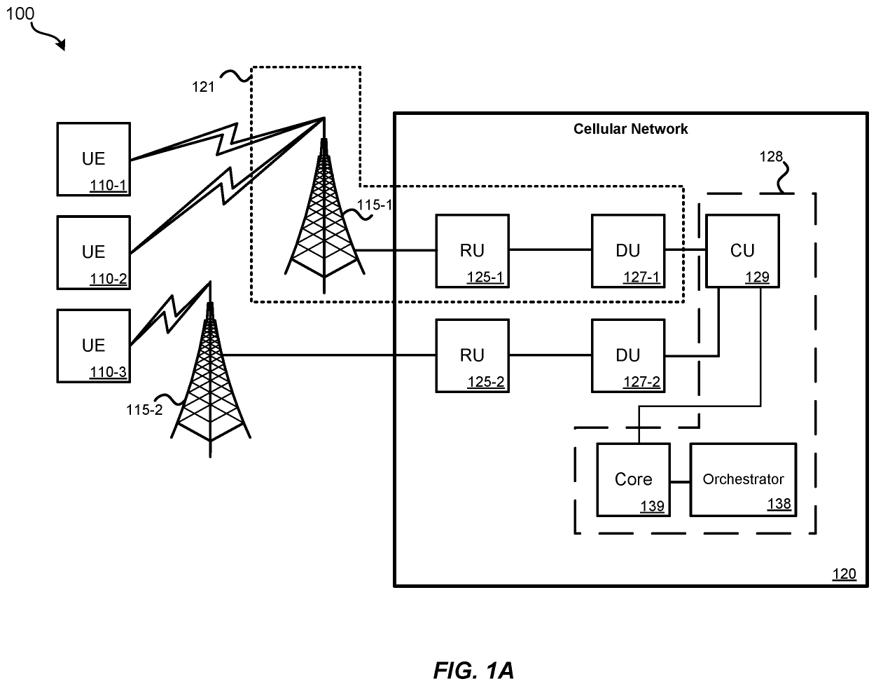

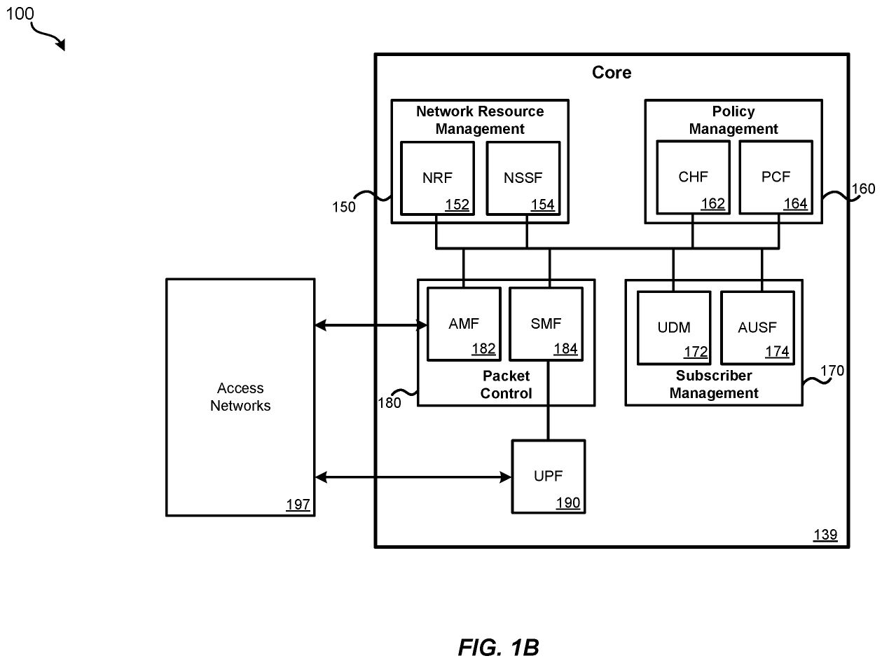

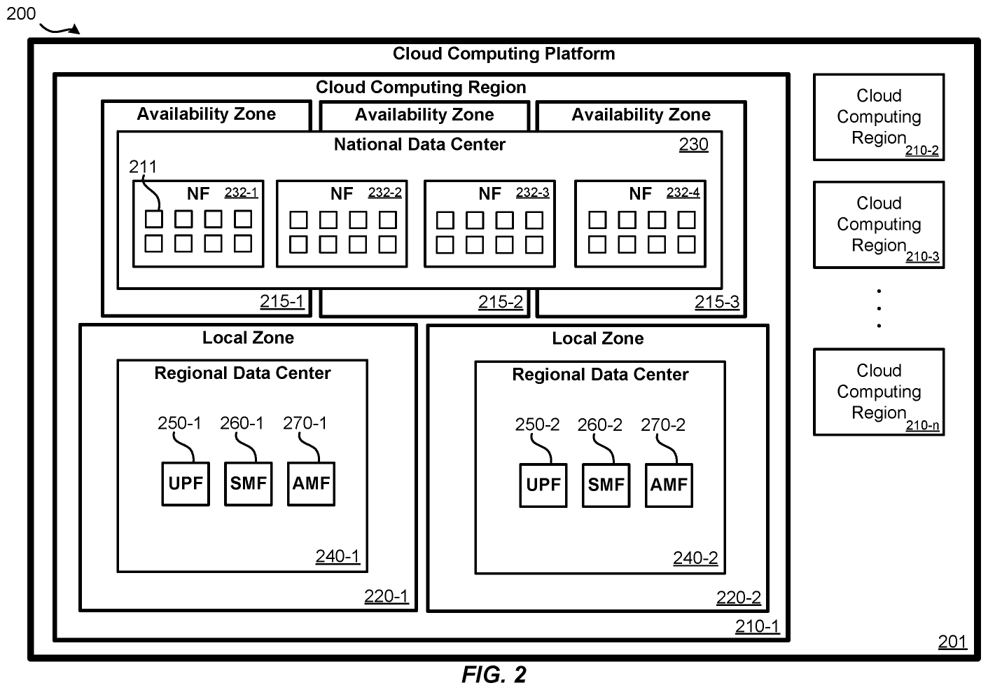

FIG. 1A illustrates an embodiment of a cellular network system 100 (“system 100”). System 100 can include a 5G New Radio (NR) cellular network; other types of cellular networks, such as 4G LTE, 6G, 7G, etc. are also possible. System 100 can include: UE 110 (UE 110-1, UE 110-2, UE 110-3); base station 115; cellular network 120; radio units 125 (“RUs 125”); distributed units 127 (“DUs 127”); centralized unit 129 (“CU 129”); core 139, and orchestrator 138. FIG. 1A represents a component level view. In a virtualized open radio access network (O-RAN), because components can be implemented as software in the cloud, except for components that need to receive and transmit RF, the functionality of various components can be shifted among different servers, for which the hardware may be maintained by a separate (public) cloud-service provider, to accommodate where the functionality of such components is needed, as detailed in relation to FIG. 2.

UE 110 can represent various types of end-user devices, such as smartphones, cellular modems, cellular-enabled computerized devices, sensor devices, manufacturing equipment, gaming devices, access points (APs), any computerized device capable of communicating via a cellular network, etc. UE can also represent any type of device that has incorporated a 5G interface, such as a 5G modem. Examples include sensor devices, Internet of Things (IoT) devices, manufacturing robots; unmanned aerial (or land-based) vehicles, network-connected vehicles, environmental sensors, etc. UE 110 may use RF to communicate with various base stations of cellular network 120. As illustrated, two base stations 115 (BS 115-1, 115-2) are illustrated. Real-world implementations of system 100 can include many (e.g., hundreds, thousands) of base stations, and many RUs, DUs, and CUs. BS 115 can include one or more antennas that allow RUs 125 to communicate wirelessly with UEs 110. RUs 125 can represent an edge of cellular network 120 where data is transitioned to wireless communication. The radio access technology (RAT) used by RU 125 may be 5G New Radio (NR), or some other RAT, such as 4G Long Term Evolution (LTE). The remainder of cellular network 120 may be based on an exclusive 5G architecture, a hybrid 4G/5G architecture, a 4G architecture, or some other cellular network architecture. Base station equipment 121 may include an RU (e.g., RU 125-1) and a DU (e.g., DU 127-1) located on site at the base station. In some embodiments, the DU may be physically remote from the RU. For instance, multiple DUs may be housed at a central location and connected to geographically distant (e.g., within a couple kilometers) RUs.

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 21. One or more DUs, such as DU 127-1, may communicate with CU 129. Collectively, RUs, DUs, and CUs create a gNodeB, which serves as the radio access network (RAN) of cellular network 120. CU 129 can communicate with core 139. The specific architecture of cellular network 120 can vary by embodiment. Edge cloud server systems outside of cellular network 120 may communicate, either directly, via the Internet, or via some other network, with components of cellular network 120. For example, DU 127-1 may be able to communicate with an edge cloud server system without routing data through CU 129 or core 139. Other DUs may or may not have this capability.

At a high level, the various components of a gNodeB can be understood as follows: RUs perform RF-based communication with UE. DUs support lower layers of the protocol stack such as the radio link control (RLC) layer, the medium access control (MAC) layer, and the physical communication layer. CUs support higher layers of the protocol stack such as the service data adaptation protocol (SDAP) layer, the packet data convergence protocol (PDCP) layer and the radio resource control (RRC) layer. A single CU can provide service to multiple co-located or geographically distributed DUs. A single DU can communicate with multiple RUs.

Further detail regarding exemplary core 139 is provided in relation to FIG. 1B. Core 139, which can be physically distributed across data centers or located at a central national data center (NDC) as detailed in relation to FIG. 2, can perform various core functions of the cellular network. Core 139 can include: network resource management components 150; policy management components 160; subscriber management components 120; and packet control components 180. Individual components may communicate on a bus, thus allowing various components of core 139 to communicate with each other directly. Core 139 is simplified to show some key components. Implementations can involve additional other components.

Network resource management components 150 can include: Network Repository Function (NRF) 152 and Network Slice Selection Function (NSSF) 154. NRF 152 can allow 5G network functions (NFs) to register and discover each other via a standards-based application programming interface (API). NSSF 154 can be used by AMF 182 to assist with the selection of a network slice that will serve a particular UE.

Policy management components 160 can include: Charging Function (CHF) 162 and Policy Control Function (PCF) 164. CHF 162 allows charging services to be offered to authorized network functions. Converged online and offline charging can be supported. PCF 164 allows for policy control functions and the related 5G signaling interfaces to be supported.

Subscriber management components 170 can include: Unified Data Management (UDM) 172 and Authentication Server Function (AUSF) 174. UDM 172 can allow for generation of authentication vectors, user identification handling, NF registration management, and retrieval of UE individual subscription data for slice selection. AUSF 174 performs authentication with UE.

Packet control components 180 can include: Access and Mobility Management Function (AMF) 182 and Session Management Function (SMF) 184. AMF 182 can receive connection- and session-related information from UE and is responsible for handling connection and mobility management tasks. SMF 184 is responsible for interacting with the decoupled data plane, creating updating and removing Protocol Data Unit (PDU) sessions, and managing session context with the User Plane Function (UPF).

User plane function (UPF) 190 can be responsible for packet routing and forwarding, packet inspection, QoS handling, and external PDU sessions for interconnecting with a Data Network (DN) 195 (e.g., the Internet) or various access networks 197. Access networks 197 can include the RAN of cellular network 120 of FIG. 1A.

While FIGS. 1A and 1B illustrate various components of cellular network 120, it should be understood that other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In a virtualized arrangement, specialized software on general-purpose hardware may be used to perform the functions of components such as DU 127, CU 129, and core 139. Functionality of such components can be co-located or located at disparate physical server systems. For example, certain components of core 139 may be co-located with components of CU 129.

In a possible O-RAN implementation, DUs 127, CU 129, core 139, and/or orchestrator 138 can be implemented virtually as software being executed by general-purpose computing equipment, such as in a data center. Therefore, depending on needs, the functionality of a DU, CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100, cloud-based cellular network components 128 include CU 129, core 139, and orchestrator 138. In some embodiments, DUs 127 may be partially or fully added to cloud-based cellular network components 128. Such cloud-based cellular network components 128 may be executed as specialized software executed by underlying general-purpose computer servers. Cloud-based cellular network components 128 may be executed on a public third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested. A “public” cloud-based computing platform refers to a platform where various unrelated entities can each establish an account and separately utilize the cloud computing resources, the cloud computing platform managing segregation and privacy of each entity's data.

Kubernetes, or some other container orchestration platform, can be used to create and destroy the logical DU, CU, or 5G core units and subunits as needed for the cellular network 120 to function properly. Kubernetes allows for container deployment, scaling, and management. As an example, if cellular traffic increases substantially in a region, an additional logical DU or components of a DU may be deployed in a data center near where the traffic is occurring without any new hardware being deployed. (Rather, processing and storage capabilities of the data center would be devoted to the needed functions.) When the need for the logical DU or subcomponents of the DU no longer exists, Kubernetes can allow for removal of the logical DU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new DU, orchestrator 138 can perform a pipeline of calling the DU code from a software repository incorporated as part of, or separate from, cellular network 120; pulling corresponding configuration files (e.g., helm charts); creating Kubernetes nodes/pods; loading DU containers; configuring the DU; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet particular SLA levels and parameters. By controlling the location and amount of computing and communication resources allocated to a network slice, the SLA attributes for UE on the network slice can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1, a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

As illustrated in FIG. 1A, UE 110 may be operating on one or more production slices of cellular network 120. As detailed later in this document, UE that function on a particular entity's local network may be assigned to a slice particular to the entity or a slice that provides a particular QoE for tasks to be performed by the entity's UE.

Components such as DUs 127, CU 129, orchestrator 138, and core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

FIG. 2 illustrates an embodiment of a cellular network core network topology 200 as implemented on a public cloud-computing platform. Cellular network core network topology 200 can represent how logical cellular network groups are distributed across cloud computing infrastructure of cloud computing platform 201. Cloud computing platform 201 can be logically and physically divided up into various different cloud computing regions 210. Each of cloud computing regions 210 can be isolated from other cloud computing regions to help provide fault tolerance, fail-over, load-balancing, and/or stability and each of cloud computing regions 210 can be composed of multiple availability zones, each of which can be a separate data center located in general proximity to each other (e.g., within 100 miles). Further, each of cloud computing regions 210 may provide superior service to a particular geographic region based on physical proximity. For example, cloud computing region 210-1 may have its datacenters and hardware located in the northeast of the United States while cloud computing region 210-2 may have its datacenters and hardware located in California. For simplicity, the details of the cellular network as executed in only cloud computing region 210-1 is illustrated. Similar components may be executed in other cloud computing regions of cloud computing regions 210 (210-2, 210-3, 210-n).

In other embodiments, cloud computing platform 201 may be a private cloud computing platform. A private cloud computing platform may be maintained by a single entity, such as the entity that operates the hybrid cellular network. Such a private cloud computing platform may be only used for the hybrid cellular network and/or for other uses by the entity that operates the hybrid cellular network (e.g., streaming content delivery).

Each of cloud computing regions 210 may include multiple availability zones 215. Each of availability zones 215 may be a discrete data center or group of data centers that allows for redundancy that allows for fail-over protection from other availability zones within the same cloud computing region. For example, if a particular data center of an availability zone experiences an outage, another data center of the availability zone or separate availability zone within the same cloud computing region can continue functioning and providing service. A logical cellular network component, such as a national data center, can be created in one or across multiple availability zones 215. For example, a database that is maintained as part of NDC 230 may be replicated across availability zones 215; therefore, if an availability zone of the cloud computing region is unavailable, a copy of the database remains up-to-date and available, thus allowing for continuous or near continuous functionality.

On a (public) cloud computing platform, cloud computing region 210-1 may include the ability to use a different type of data center or group of data centers, which can be referred to as local zones 220. For instance, a client, such as a provider of the hybrid cloud cellular network, can select from more options of the computing resources that can be reserved at an availability zone compared to a local zone. However, a local zone may provide computing resources nearby geographic locations where an availability zone is not available. Therefore, to provide low latency, certain network components, such as regional data centers, can be implemented at local zones 220 rather than availability zones 215. In some circumstances, a geographic region can have both a local zone and an availability zone.

In the topology of a 5G NR cellular network, 5G core functions of core 139 can logically reside as part of a national data center (NDC). NDC 230 can be understood as having its functionality existing in cloud computing region 210-1 across multiple availability zones 215. At NDC 230, various network functions, such as NFs 232, are executed. For illustrative purposes, each NF, whether at NDC 230 or elsewhere located, can be comprised of multiple subcomponents, referred to as pods (e.g., pod 211) that are each executed as a separate process by the cloud computing environment. The illustrated number of pods is merely an example; fewer or greater numbers of pods may be part of the respective 5G core functions. It should be understood that in a real-world implementation, a cellular network core, whether for 5G or some other standard, can include many more network functions. By distributing NFs 232 across availability zones, load-balancing, redundancy, and fail-over can be achieved. In local zones 220, multiple regional data centers 240 can be logically present. Each of regional data centers 240 may execute 5G core functions for a different geographic region or group of RAN components. As an example, 5G core components that can be executed within an RDC, such as RDC 240-1, may be: UPFs 250, SMFs 260, and AMFs 270. While instances of UPFs 250 and SMFs 260 may be executed in local zones 220, SMFs 260 may be executed across multiple local zones 220 for redundancy, processing load-balancing, and fail-over.

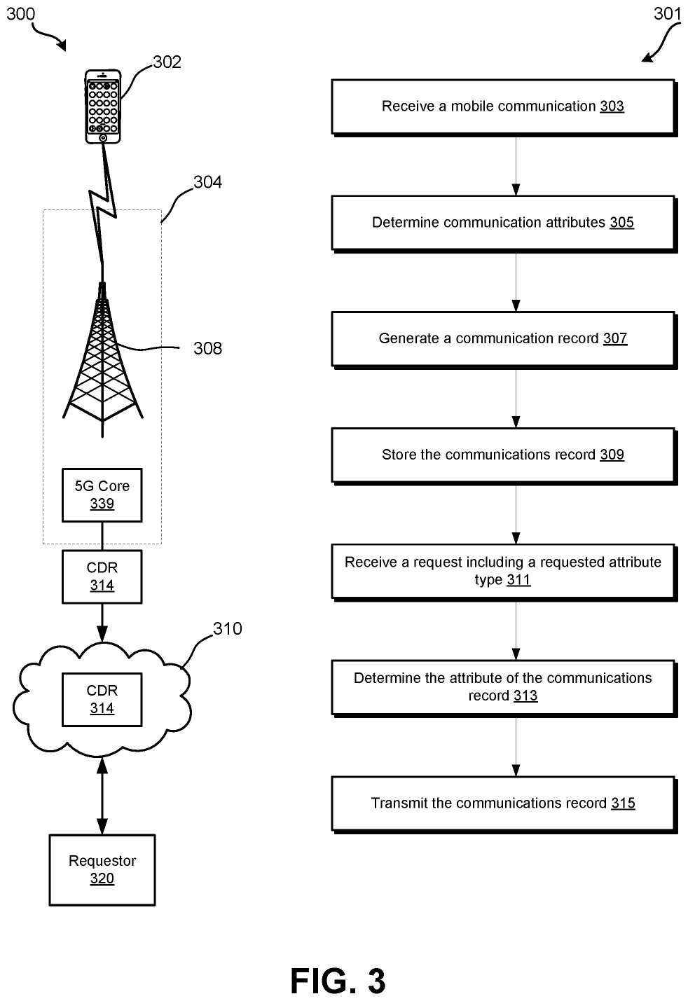

FIG. 3 illustrates a system 300 and a process 301 for collecting and providing cell-site information, according to certain embodiments. The system 300 may include a UE 302, a cellular network 304, an RU 308 and a cloud storage 310. The cellular network 304 may be similar to the cellular network system 100 described in FIGS. 1A and 1B. Although not necessarily illustrated in FIG. 3, it should be understood that the cellular network 304 may include any number of components shown in FIGS. 1A and 1B. Furthermore, one or more of the components of the cellular network 304 may be implemented in a cloud architecture, such as any commercially available cloud network.

The cellular network 304 may be a standalone 5G cellular network. The cellular network 304 may include an open radio access network (O-RAN) that provides 5G cellular service. The cellular network 304 may provide Voice Over New Radio (VoNR) service and other internet protocol (IP) based services. The RU 308 of the cellular network 304 may be associated with a cellular identifier (CID) and correspond to a geographic region. The CID may therefore correspond to location data associated with the RU 308, such as an address, a longitude and latitude, an azimuth associated with an antenna of the RU 308, and other such information.

The cellular network 304 may also include a 5G core 339 similar to the core 139, described in FIG. 1B. As such, the 5G core 339 may include similar features and functionalities. The 5G core 339 may therefore include an AMF, a CHF, a UPF, a session management function (SMF), an internet protocol multimedia subsystem (IMS) including a short message service center (SMSC), a call session control function (CSCF), a multimedia message service center (MMSC), and other network functions (sometimes “core network function(s)”). The 5G core 139 may thereby provide multiple services for and concerning the UE 302 and related communications. Additionally, one or more components of the 5G core 339 may be hosted in a public cloud service. Furthermore, the cellular network 304 should be understood to include one or more computing devices including one or more processors configured to execute instructions stored in a non-transitory computer readable memory. The one or more computing devices may be able to perform some or all of the processes and techniques described herein either alone or in conjunction with one another.

At block 303 of the process 301, the RU 308 may receive a mobile communication from the UE 302. The mobile communication may be a VoNR call, a multimedia messaging service (MMS) communication, a short message service (SMS) communication, or other such mobile communication. The cellular network 304 may enable the mobile communication to be completed, routing the mobile communication to one or more recipients.

At block 305 of the process 301, the cellular network 304 may determine one or more attributes associated with the mobile communication and/or the UE 302. The one or more attributes may include a service type (e.g., MMS, VoNR, etc.), a session ID, a start and end time of the mobile communication, the CID of the RU 308, an international mobile equipment identity (IMEI) associated with the UE 302, and other such information. One or more network functions of the cellular network 304 may work in concert to collect the one or more attributes. For example, an SMF of the 5G core 339 may determine session information of the mobile communication. The AMF may determine the CID. The UPF may determine numbers and/or addresses associated with a sender and/or a recipient of the mobile communication. One of ordinary skill in the art would recognize many different possibilities.

At block 307 of the process 301, the one or more network functions of the 5G core 339 may generate a communications record. The communications record may be a call data record (CDR) 314. The CDR 314 may include all or some of the one or more attributes. The CDR 314 may be generated by the core network function(s) of the cellular network 304. In some embodiments, the CDR 314 may be configured to include the CID of the RU 308 instead of or in addition to a gNodeB identifier associated with a CU of the cellular network 304.

In an example, the mobile communication may be an MMS or SMS message from the UE 302. The mobile communication may therefore be received via the IMS of the cellular network 304. The IMS may not provide all of the attributes of the mobile communication needed to generate the CDR 314. A computing device of the cellular network 304 may therefore access a logical interface. The logical interface may enable data associated with the one or more attributes of an MMS and/or an SMS message to be extracted and entered into the CDR 314. In some embodiments, the communications record is a log generated by the core of the cellular network. The log may be configured to include only those attributes that may be lawfully requested by a law enforcement agency.

At block 309 of the process 301, the computing device of the cellular network 304 may store the CDR 314 in the cloud storage 310. The cloud storage 310 may be implemented in a public cloud service, instead of a closed cloud network architecture. The CDR 314 may be stored indefinitely or stored for a specific amount of time (e.g., a year).

At block 311 of the process 301, the computing device of the cellular network 304 may receive a request for communications records from a requestor 320. The requestor 320 may be an agency requesting communications records associated with the RU 308 pursuant to a warrant or other order. The request may identify an attribute type and request all communications records associated with the attribute type. For example, the attribute type may be a time window. The request may request all communications records for all mobile communications made via the RU 308 within the time window. The request may additionally or alternatively identify a location of the RU 308. In another example, the request may include an identifier such as the IMEI associated with the UE 302, an International Mobile Subscriber Identity (IMSI), an Mobile Station International Subscriber Directory Number (MSISDN), and/or other identifiers, and therefore only request communications records associated with the UE 302.

At step 313 of the process 301, the computing device of the cellular network 304 may determine that the communications record includes an attribute of the request attribute type. For example, the request may include a time window. The computing device of the cellular network 304 may then determine one or more communications records that correspond to the RU 308 and have an attribute matching the time window (e.g., the CDR 314). At step 315 of the process 301, the computing device may transmit the communications record to the requestor 320. In some embodiments, the communications record may be the CDR 314. In other embodiments, the communications record may be a log generated by the AMF or another network function of the cellular network 304.

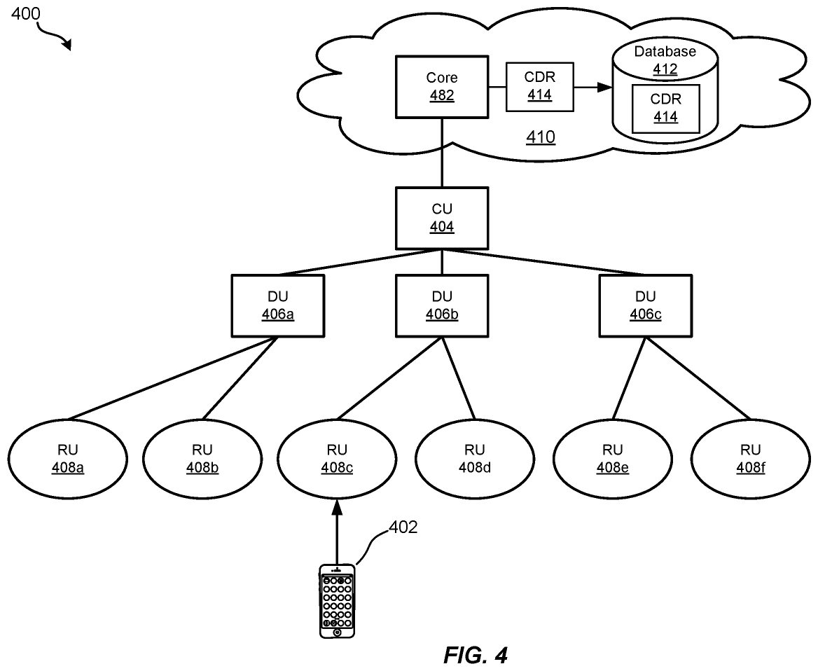

FIG. 4 illustrates a simplified diagram of a system 400 for collecting cell-site information, according to certain embodiments. The system 400 may include some or all of the components described in FIGS. 1A, 1i, and 2. The system 400 may also perform some or all of the steps of the process 301 in FIG. 3. The system 400 may include a UE 402, a CU 404, DUs 406a-c, RUs 408a-f, and a cloud network 410. The cloud network 410 may include a core 482 and a database 412 containing a CDR 414. Some or all of the system 400 may be included in a cellular network such as the cellular network 304 in FIG. 4. As such, the system 400 may represent components of a standalone 5G cellular network. The UE 402 may be similar to the UE 302 in FIG. 3, capable of performing mobile communications through a 5G cellular network.

The core 482 may be similar to the 5G core 339 in FIG. 3, and include similar components, network functions, and capabilities.

The CU 404 may include physical entities (e.g., a tower) and/or software defined radio (SDR) modules. The CU 404 may also be associated with the DUs 406a-c. The CU 404 and DUs 406a-c may be responsible for orchestrating various tasks and services to enable mobile communications using the cellular network (e.g., scheduling, etc.). The CU 404 and the DUs 406a-c may therefore form all or some of a gNodeB. The gNodeB may also have an associated gNodeB ID included in some or all communications records generated in response to mobile communications made via the CU 404 (and associated components).

Each of the DUs 406a-c may be associated with one or more RUs 408a-f. Each of the RUs 408a-f may be similar to the RU 125 in FIG. 1A and be characterized by a particular operating frequency and/or geographic location. The RUs 408a-f may be responsible for direct radio communication with a UE, such as the UE 402. In the case that each of the RUs 408a-f is dedicated to a particular region, each RU 408a-f may be associated with a respective CID.

The UE 402 may initiate (or receive) a mobile communication through RU 408c. The mobile communication may include a VoNR call, an SMS communication, an MMS communication, and/or other such mobile communications. The mobile communication may then be passed to the DU 406b and the CU 404. The mobile communication (and data associated thereto) may then be passed to one or more network functions of the cellular network and/or the core 482. For example, the mobile communication may be completed using a UPF, session-related services may be provided by an SMF, etc. Location services may be provided, at least in part, by an AMF. Using information from at least some of the network functions, the core 482 may generate the CDR 414. The CDR 414 may include location data, session data, call records (e.g., inbound/outbound device numbers), an IMEI of the UE 402, and other such information. The CDR 414 may then be stored in the database 412.

In other cellular networks, such as 4G networks and/or non-standalone 5G networks, a CDR may include a base station identifier. For example, a 4G network may include an eNodeB identifier. A mobility management entity (MME) of the 4G network may generate a log (or CDR) including the eNodeB ID. Similarly, a non-standalone 5G network may also include the node ID, as the non-standalone 5G network may utilize a 4G core (and thus include an MME). However, these cellular networks may include a one-to-one correspondence between the node ID and a CID. Including the node ID (either eNodeB or gNodeB) in a log and/or CDR therefore may identify the CID appropriately.

In the system 400, by contrast, the gNodeB ID may be (most directly) associated with the CU 404. The system 400 may also include six respective CIDs, each associated with an RU of the RUs 408a-f. Therefore, the gNodeB ID included in the CDR 414 and/or a log may be associated with each of the six respective CIDs. In other words, the gNodeB ID may only provide a general geographic location and/or a plurality of base stations associated with the gNodeB. If the gNodeB ID is used to identify the location of the mobile communication, a request for communications records associated with a particular base station (e.g., RU 408c) may return records for every mobile communication made via each of the RUs 408a-f, providing more data than is needed to comply with the request. By modifying the core 482 to generate the CDR 414 to include the CID associated with the RU 408c, the requested communications record(s) may be provided more efficiently, while not providing information for mobile communications outside of the scope of the request. The privacy of users making the mobile communications may therefore be better protected. In some embodiments, one or more functions of the core 482 may be modified to generate a log of each mobile communication made via the system 400, including a CID associated with each mobile communication.

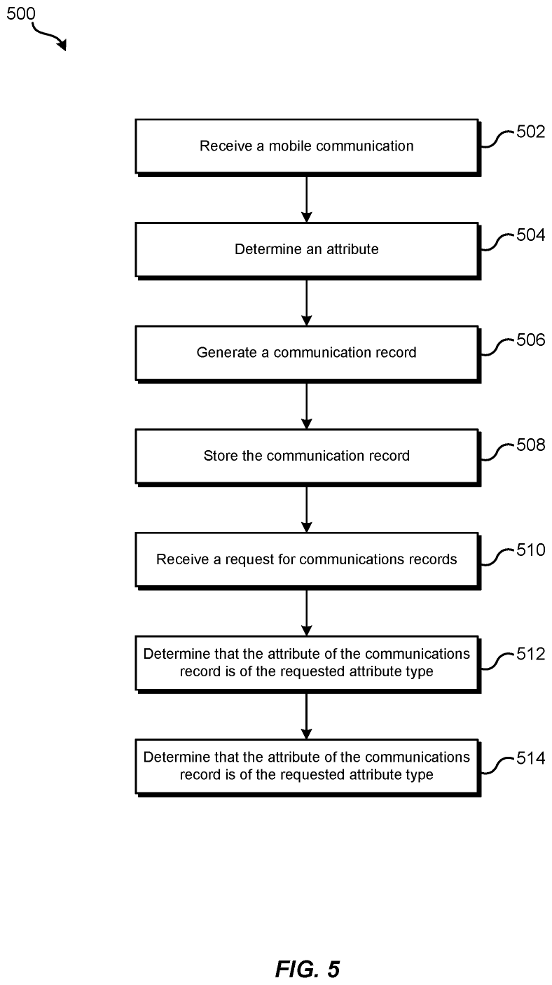

FIG. 5 illustrates a flow chart of a method 500 for collecting and providing cell-site information, according to certain embodiments. The method 500 may be performed by all or some of the systems described herein, such as the system 100 in FIGS. 1A and 1B (and including some or all of the components described in FIG. 2), the system 300 in FIG. 3, and the system 400 in FIG. 4. Accordingly, some or all of the method 500 may be performed by a standalone 5G cellular network with an O-RAN using cloud-based computing and architectures. Some of the steps of the method 500 may be performed in a different order than is described herein and/or skipped altogether.

At step 502, the method 500 may include receiving, by an RU of a cellular network, a mobile communication from a user device. The RU may be associated with a CID. The cellular network may include standalone 5G network and/or an O-RAN network. As such, the cellular network may include one or more network functions that provide services for facilitating mobile communications through the cellular network. The mobile communication may be a VoNR communication, an SMS communication, an MMS communication, or any other suitable mobile communication. The CID may be associated with a particular address or location of the RU (e.g., base station).

At step 504, the method 500 may include determining, by an AMF of the cellular network, one or more attributes associated with the user device and/or the mobile communication. The one or more attributes may include a service type (e.g., MMS, VoNR, etc.), a session ID, other session information, a start and end time of the mobile communication, the CID of the RU, a location of the RU, an international mobile equipment identity (IMEI) associated with the UE, and other such information. The one or more network functions of the cellular network may work in concert to collect the one or more attributes. For example, an SMF of a 5G core may determine session information of the mobile communication. The AMF may determine the CID and/or other location data. One of ordinary skill in the art would recognize many different possibilities.

At step 506, the method 500 may include generating, by a core network function of the cellular network, a communications record of the mobile communication. The communications record may include the CID associated with the RU and an indication of each of the one or more attributes (e.g., a timestamp). The core network function may include the AMF, the SMF, an SMSC, a CSCF, and/or a MMSC. In some embodiments, the communications record may include a CDR, similar to the CDR 314 in FIG. 3. The CDR may include some or all of the one or more attributes. The CDR may also include a gNodeB identifier in addition to the CID. The CDR may be modified to include the CID instead of the gNodeB identifier. Additionally or alternatively, the communications record may include a log of the mobile communication. The log may include the same or different information than the CDR. In some embodiments, the AMF may facilitate the creation the communications record in conjunction with other network functions (e.g., the SMF, a call session control function (CSCF), and other functions of a cellular network core).

In some embodiments, the mobile communication may include an SMS communication. The method 500 may then include accessing, by a core network function(s) of the of the cellular network (e.g., the SMSC), an interface for extracting data associated with the SMS communication (e.g., data associated with the one or more attributes) from an IMS and/or an non-access stratum (NAS). The core network function may access the interface via other network functions, or via a separate computing device of the cellular network. The computing device may then extract data corresponding to the one or more attributes of the SMS communication from the IMS. The core network function may then generate the communications record based at least in part on the data associated with the SMS communication.

In some embodiments, the mobile communication may include an MMS communication. The method 500 may then include accessing, by the core network function(s) of the cellular network (e.g., an MMSC), an interface for extracting data associated with the MMS communication (e.g., data associated with the one or more attributes) from an IMS. The core network function may access the interface via other network functions, or via a separate computing device of the cellular network. The computing device may then extract data corresponding to the one or more attributes of the MMS communication from the IMS. The core network function may then generate the communications record based at least in part on the data associated with the MMS communication.

At step 508, the method 500 may include storing, by a computing device of the cellular network, the communication record in a cloud-based database. The cloud-based database may be hosted by a commercially available cloud services provider. The computing device may store the communications record as a result of instructions from the core network function.

At step 510, the method 500 may include receiving, by the computing device of the cellular network, a request for communications records. The request may include an attribute type. For example, the attribute type may be a time window for a particular location (e.g., a radius about an address, etc.). The request may be a warrant or other lawful request from a law enforcement agency. The request may additionally or alternatively identify a particular UE via an IMEI, an IMSI, or other such identifier.

At step 512, the method 500 may include determining, by the computing device of the cellular network, that an attribute of the one or more attributes is of the requested attribute type. For example, the cloud-based database may include all communications records for a given region or all communications records generated from the cellular network. The computing device may filter the communications records by a location indicated in the response. The filtered communication records may only include those communications records with a CID corresponding to the location indicated in the request. The computing device may then determine a subset of the filtered communications records that includes an attribute of the requested attribute type. If the requested attribute type is a time window (e.g., 12-2 pm on January 1), the subset may therefore only include communications records with the CID corresponding to the indicated location associated with mobile communications made on January 1 between 12 pm and 1 pm.

In response to determining that the attribute is of the requested attribute type, at step 514, the method 500 may include transmitting, by the computing device of the cellular network, the communication record based on the request. For example, the request may identify a requestor. The computing device may therefore transmit the communications record to the requestor, per the request.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method, comprising:
receiving, by a radio unit (RU) of a cellular network, a mobile communication from a user device, the RU associated with a cell identifier (CID);
determining, by an access and mobility function (AMF) of the cellular network, an attribute associated with the user device and the mobile communication;
generating, by a core network function of the cellular network, a communication record of the mobile communication, the communication record comprising the CID and an indication of the attribute;
storing, by a computing device of the cellular network, the communication record in a database;
receiving, by the computing device of the cellular network, a request for communication records, the request comprising a requested attribute type;
determining, by the computing device of the cellular network, that the attribute of the communication record is of the requested attribute type; and
in response to determining that the attribute of the communication record is of the requested attribute type, transmitting, by the computing device of the cellular network, the communication record based on the request.

2. The method of claim 1, wherein the communication record is a call data record comprising information associated with the mobile communication and the CID.

3. The method of claim 1, wherein the attribute comprises at least one of a time window, an international mobile equipment identity of the user device, an international mobile subscriber identity (IMSI), a communication length, a session identifier, and a location associated with RU.

4. The method of claim 1, wherein the mobile communication includes a short message service (SMS) communication, the method further comprising:
accessing, by the core network function of the cellular network, an interface for extracting data associated with the SMS communication from at least one of an internet protocol multimedia subsystem (IMS) and a non-access stratum (NAS);
extracting, by the core network function of the cellular network, the data associated with the SMS communication from the IMS and/or the NAS; and
generating, by the core network function of the cellular network, the communications record based at least in part on the data associated with the SMS communication.

5. The method of claim 1, wherein the mobile communication includes a multimedia messaging service (MMS) communication, the method further comprising:
accessing, by the core network function of the cellular network, an interface for extracting data associated with the MMS communication from an internet protocol multimedia subsystem (TMS);
extracting, by the core network function of the cellular network, the data associated with the MMS communication from the IMS; and
generating, by the core network function of the cellular network, the communications record based at least in part on the data associated with the MMS communication.

6. The method of claim 1, wherein the cellular network comprises a standalone 5G network.

7. The method of claim 6, wherein the standalone 5G network comprises an open radio access network.

8. The method of claim 6, wherein the standalone 5G network comprises one or more of the AMF, a session management function (SMF), a short message service center (SMSC), a call session control function (CSCF), a multimedia message service center (MMSC), the computing device, and the database in a distributed cloud architecture.

9. The method of claim 1, wherein the communications record is modified to replace a gNodeB identifier with the CID.

10. A system, comprising:
one or more processors;
a non-transitory computer readable medium comprising instructions that, when executed by the one or more processors, cause the system to perform operations to:
receive, by a radio unit (RU) of a cellular network, a mobile communication from a user device, the RU associated with a cell identifier (CID);
determine, by an access and mobility function (AMF) of the cellular network, an attribute associated with the user device and the mobile communication;
generate, by a core network function of the cellular network, a communication record, the communication record comprising the CID and an indication of the attribute;
store, by a computing device of the cellular network, the communication record in a cloud-based database;
receive, by the computing device of the cellular network, a request for communication records, the request comprising a requested attribute type;
determine, by the computing device of the cellular network, that the attribute of the communication record is of the requested attribute type; and
in response to determining that the attribute of the communication record is of the requested attribute type, transmit, by the computing device of the cellular network, the communication record based on the request.

11. The system of claim 10, wherein a distributed unit (DU) is associated with the RU and at least one other RU.

12. The system of claim 11, wherein a centralized unit (CU) is associated with the DU and at least one other DU, the CU characterized by a gNodeB identifier.

13. The system of claim 12, wherein the communications record is modified to replace the gNodeB identifier with the CID.

14. The system of claim 10, wherein the cellular network comprises a standalone 5G network.

15. The system of claim 14, wherein the standalone 5G network comprises one or more components distributed in a cloud architecture.

16. The system of claim 10, wherein the core network function comprises at least one of, a session management function (SMF), a short message service center (SMSC), a call session control function (CSCF), and a multimedia message service center (MMSC).

17. The system of claim 10, wherein the attribute comprises at least one of a time window, an international mobile equipment identity of the user device, international mobile subscriber identity (IMSI), a communication length, a session identifier, and a location associated with RU.

18. The system of claim 10, wherein the communications record is generated by the core network function in conjunction with another network function of the cellular network.

19. The system of claim 10, wherein the mobile communication is a voice over new radio (VoNR) communication.

20. A computer-readable, non-transitory computer memory comprising instructions that, when executed by one or more processors, cause the one or more processors to perform operations comprising:
determining, by an access and mobility function (AMF) of a cellular network, an attribute associated with a user device and a mobile communication;
generating, by a core network function of the cellular network, a communication record of the mobile communication, the communication record comprising the CID and an indication of the attribute;
storing, by a computing device of the cellular network, the communication record in a database;
receiving, by the computing device of the cellular network, a request for communication records, the request comprising a requested attribute type;
determining, by the computing device of the cellular network, that the attribute of the communication record is of the requested attribute type; and
in response to determining that the attribute of the communication record is of the requested attribute type, transmitting, by the computing device of the cellular network, the communication record based on the request.
